(19) United States
(12) Patent Application Publication
(10) Pub. No.: US 2010/0025395 A1
(43) Pub. Date: Feb. 4, 2010

(54) Apparatus for the heating of molding, in particular dental-ceramic moldings

(75) Inventors: Jurgen Laubersheimer, Buchs (CH); Rudolf Jussel, Feldkirch-Tosters (AT); W. Lautenschlager, Heerbrugg (CH); Christian Werling, Lindau (DE)

Correspondence Address: John C. Thompson, 69 Grayton Road, Tonawanda, NY, 14150, US

(73) Assignee: Ivoclar Vivadent AG

(21) Appl. No.: 12/455,828

(22) Filed: Jun. 8, 2009

(30) Foreign Application Priority Data
Jul. 29, 2008 (DE) 10 2008 035 235.7

(51) Int. Cl. H05B 6/80

(52) U.S. Cl. 219/759

(57) ABSTRACT

This invention relates to a device for heating moldings, in particular dental ceramic moldings with the aid of a microwave generator that impinges a susceptor with microwave radiation, said susceptor being arranged between the molding and the microwave generator. Preferably, the susceptor at least partially forms both an inner ring and an outer ring, and the molding is arranged between the inner ring and the outer ring.

### CROSS-REFERENCE TO RELATED APPLICATIONS

This application claims foreign priority benefits under 35 U.S.C. §119(a)-(d) from German patent application ser. no. P 10 2008 035 235.7 filed Jul. 29, 2008.

### TECHNICAL FIELD

The invention relates to an apparatus for the heating of moldings, and in particular for heating dental-ceramic moldings in a microwave oven.

### BACKGROUND OF THE INVENTION

An oven of this kind is known for example from EP 1 060 713 A1. In an oven of this kind, dental-ceramic parts are exposed to microwave radiation, whereby it is also possible to use susceptors that absorb microwave radiation and heat up through this, as a result of which the dental molding is also heated up.

Strength on the one hand, and elasticity of dental-ceramic parts on the other hand, strongly depend on the thermal treatment, in particular on the firing- or sintering curve, respectively. Whereas dental ceramic parts that are heated with the aid of conventional infrared heating typically tend to sinter or bake from the outside to the inside, after the heat released had been supplied to the dental molding from the outside by means of thermal radiation or convection, microwaves exhibit the advantage of being basically also suitable for heating up a dental molding part starting from the inside.

On the other hand, commercially available microwave ovens typically have the disadvantage that a strong local temperature gradient occurs, for which reason also quite simple microwave ovens use rotary tables for rotating either the parts or the batch to be heated or the microwave radiation emitted in order to thus achieve a certain homogenizing effect.

Various attempts have been made to homogenize the microwave radiation in dental firing furnaces. For this reason, rotary tables have also been proposed for the dental field, whereas the tests have shown that the material properties of the sintered moldings nevertheless are not quite satisfactory.

Thus, there is still the endeavor to further improve a uniform heating. In this case, for example, it has already been proposed to use susceptors having particularly thick walls in order to achieve a higher homogenizing effect in this respect. Thus, the microwave radiation is converted into thermal energy which is applied to the one or more moldings from its outer surface, such that this approach rather is similar to a firing furnace that is thermally operated in a classical manner, but always heats the moldings from the outside to the inside.

With such a heating, however, temperature gradients arise inevitably, in particular, since it is regularly endeavored to keep the burning cycle time low and thus enable quick heating and comparably quick cooling down.

### OBJECTS AND SUMMARY OF THE INVENTION

The present invention is based on the object of providing an apparatus for the heating of moldings, in particular dental-ceramic moldings, said apparatus enabling an improved restoration result without requiring an extension of the cycle time, and by means of which the cycle time can preferably be reduced.

According to the invention it is provided to build an inner ring and an outer ring of susceptors around the molding, said molding being accommodated in the ring space formed in this way. Surprisingly, this measure leads to a more uniform heating based on the fact that by means of the susceptors having large surfaces but comparably thin walls, a certain portion of the microwave radiation enters into the ring space, and an equilibrium of the thermal radiation and the microwave radiation emitted by the susceptors is generated in this respect. This equilibrium results in the uniform heating of the molding both from the inside and from the outside such that the temperature gradient—in case the inner ring and the outer ring are correctly positioned—is strongly reduced, even if a comparably high power and thus a rapid heating are employed.

In a simple embodiment, both the inner ring and the outer ring are formed as upright standing rings, between which the ring space extends, whereas none of the two rings obligatorily has to be completely closed. In this case, neither in the inner ring nor in the outer ring there is a considerable flow of current, and both rings act as passive susceptors.

In an advantageous refinement, however, it is possible to form the rings in a closed manner and to build the same from a temperature-resistant semiconductor material that acts as a susceptor for the microwave radiation at the same time. In case of this closed ring shape, microwave radiation is then induced and the induced currents act as power consumers or sinks and in this respect additionally convert microwave radiation into heat. In this case, the semiconductor basically also acts as an ohmic resistor that emits lost heat.

Due to the ring space it is possible to attach the susceptors relatively close to the moldings, even if a plurality of moldings is simultaneously fired, such that the thermal coupling is particularly expedient. The result is the desired homogenizing of the heating due to the combined effect of the thermal radiation and the microwave radiation that each have opposed local heating profiles.

According to the invention it is particularly expedient that the microwave radiation—even without a rotary table—can be absorbed to a large extent by the comparatively large wall areas that—for the microwave radiation—represent a space in the form of a ring-shaped susceptor for receiving the molded parts, whereas it is basically possible to use a microwave hybrid kiln, even if this is not necessarily required due to the good absorption properties. Due to the partial transparency of the susceptors to microwave radiation, nevertheless a microwave impingement also of the moldings takes place which serves to ensure the desired thermal equilibrium.

In a particular favorable arrangement, the height, but also the diameter of the rings, that is to say of the inner ring and the outer ring, are multiples or divisors of the wavelength of the microwave radiation that is emitted by the microwave generator. For example, the wavelength 1 of the microwave radiation used can amount to 120 mm, and the height of both the inner ring and the outer ring can then amount to 120 mm, 60 mm or 30 mm.

It is to be noted that both the wavelength and accordingly the generator frequency of the microwave generator are adjustable to the requirements to a large extent, whereby it is preferred for financial reasons to use standard microwave generators having an emission frequency of 2.45 GHz.

Preferably, the rings are arranged concentrically relative to one another, and the mold space extending between them, that is to say the ring space for receiving the moldings, comprises a circular ring-shaped bottom that simultaneously serves to spatially determine the rings relative to one another, or individual spacers are mounted to determine the position of the rings. Any suitable materials that have a microwave radiation-absorbing effect already at low temperatures, can be used as susceptors. The susceptors have a comparatively small wall thickness of a few millimeters at the most that contributes to the fact that the susceptors preferably partially absorb the microwave radiation. The susceptors are accordingly capable of surrounding the moldings in the manner of a container, that is to say in a closed manner, whereby the microwave radiation nevertheless is fed to the pertaining molding in the desired manner.

Instead of this, however, it is also possible to provide connectors for the supply and deduction of gasses in the susceptor for example, whereby the circular ring-shaped susceptor can also be formed like a two-part container with a lid.

Materials that can be used for forming the rings, are as follows: silicon carbide, titanium carbide, zirconium carbide, hafnium carbide, vanadium carbide, tantalum carbide, molybdenum carbide, niobium carbide, silicon boride, hafnium boride, circonium boride, silicon nitride, circonium nitride, calcium boride or mixtures thereof, but also for example in combination with Al2O3, Si₃N4 and/or BaTiO3.

According to the invention it is particularly expedient, if a good thermal conduction is ensured above the bottom of the susceptor that extends between the inner ring and the outer ring, said thermal conduction ensuring that the microwave radiation which has been absorbed by the rings and has been transformed into thermal radiation, is supplied to the moldings. In this case it is favorable if each of the rings is in thermal connection with the bottom.

According to the invention it is also favorable that by means of the combined supply of both thermal energy and microwave energy it is possible to quicker heat up the moldings.

In a further advantageous development it is provided that the susceptor generates a ring space between the inner ring and the outer ring, the radial extension of which substantially remains constant and in particular amounts to between half and double the diameter of the height of the rings.

In a further advantageous refinement it is provided that the inner ring and/or the outer ring of the susceptor have an elliptical or circular shape.

In a further advantageous refinement it is provided that both the inner ring and the outer ring each have a cross-section of an upright standing rectangle, the height of which amounting to between 20% and 120% of the diameter of the ring, preferably to between 50% and 85% and in particular to between 65% and 75% of the ring diameter.

In a further advantageous refinement it is provided that the inner ring and the outer ring generate a container that is in particular closed and forms a thermal treatment chamber with a homogeneous temperature field, said container accommodating the one or more moldings that are to be heated and being particularly at least partially transparent to microwave radiation.

In a further advantageous refinement it is provided that the inner ring and the outer ring as a susceptor absorb microwave radiation and emit thermal radiation in a homogenized manner.

In a further advantageous refinement it is provided that the inner ring and/or the outer ring each form a closed circuit and are in particular embodied as semiconductors.

In a further advantageous refinement it is provided that the susceptor is embodied as a semiconductor and has a protective layer of silicon dioxide applied on its upper surface that is also electrically insulating.

In a further advantageous refinement it is provided that the ring-shaped susceptor elements of the susceptor are electrically insulated relative to one another and are in particular arranged on an electrically insulating surface.

In a further advantageous refinement it is provided that each susceptor element has a substantially uniform height and/or wall thickness that in particular exceeds the height of the molding many times over.

In a further advantageous refinement it is provided that at least one susceptor element has a circular-symmetric shape and is in particular pivot-mounted about its axis.

In a further advantageous refinement it is provided that the wall thickness of one susceptor element amounts to a seventieth fraction to a fortieth fraction of the wavelength 1 of the microwave radiation generated by the microwave generator, and in particular has a thickness of between 1.8 mm and 2.5 mm.

In a further advantageous refinement it is provided that the height of each susceptor element has a common factor with the the wavelength 1 of the microwave generator, in particular is ½ or ¼.

In a further advantageous refinement it is provided that the susceptor elements are arranged in a concentric manner relative to one another and are in particular formed integrally.

In a further advantageous refinement it is provided that the susceptor elements are connected to each other by means of a circular ring-shaped bottom or by means of a spacer.

In a further advantageous refinement it is provided that a circular ring-shaped space is generated between the susceptor elements, said space being provided with a bed of balls that in particular consist of densely sintered zirconium oxide and/or Al₂O₃, and/or wherein the space comprises hollow balls, broken balls, powder or so-called flakes.

### BRIEF DESCRIPTION OF THE FIGURES

Further advantages, details and features emerge from the following description of an exemplary embodiment of the invention with reference to the drawings, in which:

FIG. 1 shows a diagrammatic view of a detail of a device according to the invention for the heating of moldings in a first embodiment; and

FIG. 2 illustrates a perspective view of the detail of FIG. 1.

### DETAILED DESCRIPTION

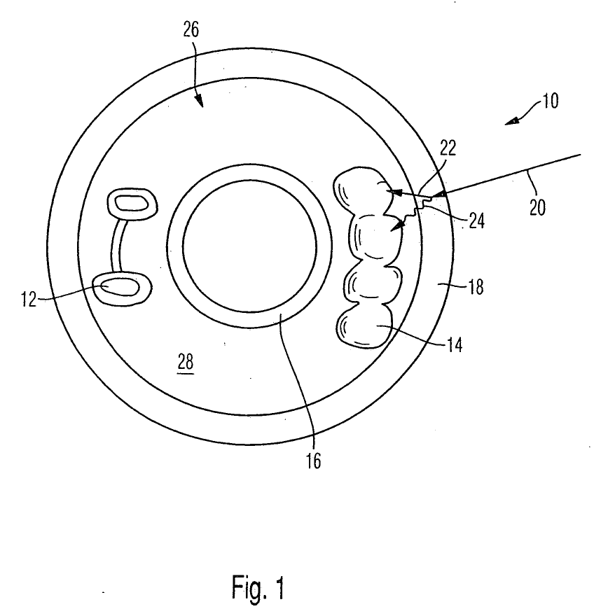

FIG. 1 shows a diagrammatic view of an inventive embodiment of a detail of the device for heating dental ceramic moldings, said view illustrating a mold cavity 10. Said mold cavity 10 is substantially ring-shaped and receives the moldings 12 and 14. It is to be noted that instead of this arrangement, it is also possible to inventively use any other number and arrangement of moldings.

The mold cavity 10 further comprises at least one inner ring 16 and one outer ring 18. It is arranged in a firing furnace (not shown) that is impinged with microwave radiation with the aid of a microwave generator.

The inner ring 16 and the outer ring 18 extend concentrically relative to one another according to the manner of flat cylinders, whereby the diameter of the inner ring 16 in the illustrated exemplary embodiment amounts to approximately one third of the diameter of the outer ring 18. The height of the outer ring amounts to approximately half of its diameter, whereas in the illustrated exemplary embodiment the height of the inner ring 16 is somewhat smaller, as it will be described in the following description.

The inner ring 16 and the outer ring 18 in the preferred exemplary embodiment are made of silicon carbide and in this respect act as susceptors.

In the exemplary embodiment illustrated, both the inner ring and the outer ring have cylindrical shape. It is to be noted that instead of using this ring shape, it is also possible to impart a truncated conical shape to the inner ring and/or outer ring, or a shape that is approximated to a hemisphere.

Further, it is not necessary for the rings to be completely closed. This especially applies for the case, when comparatively large wall thicknesses are used for the rings, whereby the entry of microwave radiation into the molding is simplified by providing one or more corresponding recesses or by realizing segments, whereas it is to be noted that a closed arrangement enables the implementation of an induction coil. On the other hand, it is parti [symbol] moldings.

This case is schematically illustrated in FIG. 1, the arrow 20 indicating the microwave radiation supplied to the mold cavity 10 by the microwave generator. The arrow 22 shows the microwave radiation emitted by the susceptor in the form of the outer ring 18, whereas the arrow 24 shows the thermal radiation emitted to the molding 14 by the susceptor 18.

When heating the dental firing furnace, the susceptors 16 and 18 act as microwave receptors in a known manner, whereas a molding 14 consisting of zirconium oxide for example, only couples at temperatures above approximately 700° C. and then absorbs incident microwaves.

It is preferred that the material which is used for the outer ring 18 and the inner ring 16, is of such nature that it is partially transparent to microwaves. Preferably, open-pored silicon carbide is used in this case which also can be recrystallized and which has a comparatively coarse crystalline structure and a rough surface. The porosity preferably amounts to between 5 and 15%, in particular approximately 10%, and the density amounts to approximately 90%, whereby also density values between 85 and 95% TD exhibit the desired effect.

It is to be noted that in a modified arrangement of the susceptors according to the invention it is also possible to successfully employ a porosity of up to 25%.

On the one hand, silicon carbide is chemically inert, and on the other hand, it has a high dielectric loss factor. According to the invention, however, it is also preferred to make use of the fact that silicon carbide is a semiconductor as well. The currents induced thus produce an electrical power loss in the material-specific internal resistance existing within the susceptor.

Preferably, both the inner ring and the outer ring have an extremely thin wall thickness, for example approximately 2 mm. With such a wall thickness, the mechanical strength is still given to a sufficient extent. The transparency to the microwave radiation, however, is also given in the desired manner, and in particular, the electric resistance is higher than with larger wall thicknesses.

According to the invention it is particularly expedient that both the molding 12 and the molding 14 are arranged in the ring space that is generated between the inner ring 16 and the outer ring 18. This arrangement increases the evenness or uniformity of the temperature distribution in a surprisingly significant manner when heating the dental firing furnace that is primarily operated on microwave radiation. Despite of the round and in this respect uniformly impingeable total arrangement of the mold cavity, the moldings can also optimally supplied with thermal energy that acts in a compensative manner when heating the moldings.

In the embodiment according to FIG. 1 two moldings 12 and 14 are received within the ring space 26 between the inner ring 16 and the outer ring 18. The dimensions are selected such that also the largest existing dental replacement parts can be received within the ring space 26. In this case, it is particularly expedient if for one time a very large molding, formed according to the human jaw with substantially U-shape in this respect, is to be fired, said molding can be inserted such that it extends to both sides of the inner ring 16.

The ring space 26 preferably is provided with a bottom that consists of the same material as the rings 16 and 18. If silicon carbide is used, use is made of the fact that the surface of silicon carbide typically oxidizes to become silicon dioxide that is electrically nonconducting, such that an insulation forms between the inner ring 16 and the bottom 28 on the one hand, and between the bottom 28 and the outer ring 18 on the other hand.

In the embodiment according to FIG. 1, the moldings 12 and 14 are received on a bed of balls that either can consist of balls made of zirconium oxide, or of a microwave-transparent insulation material, whereby it is also possible to use Al₂O₃ or for example Si₃N₄.

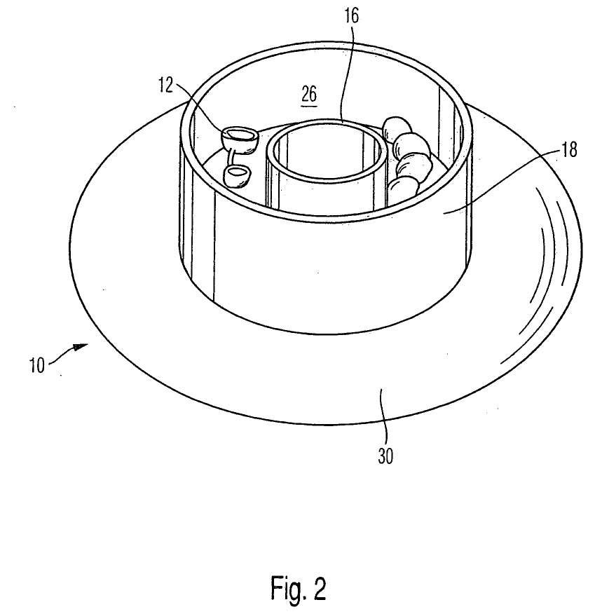

The embodiment according to FIG. 1 is illustrated in perspective view in FIG. 2. The inner ring 16 according to FIG. 2 extends over a somewhat smaller height than the outer ring 18. A cover (not shown) can be closely fit above the inner ring 16 into the outer ring 18 so that a closed ring space 26 forms in connection with the bottom 28.

The cross-section of the ring space 26 is substantially square-shaped or upstanding rectangular to some extent with a height-width-relationship of 1.5 to 1. It is to be noted that the dimensions of the mold cavity 10 according to the invention are largely adjustable to the requirements. Further, it is possible to support the mold cavity 10 according to the invention on a rotary table 30 that enables a still better improved homogenization of the microwave impingement.

Due to the tight tying of the dental structure with the rings 16 and 18 acting as susceptors, it is possible to considerably reduce the heating time, wherein in tests it has been possible to reduce the heating time to little less than half of the time required in a microwave oven according to the prior art.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

What is claimed is:

1. Apparatus for the heating of moldings, in particular dental-ceramic moldings with the aid of a microwave generator that applies microwave radiation to a susceptor, said susceptor being arranged between the molding and the microwave generator, characterized in that the susceptor at least partially forms both an inner ring (16) and an outer ring (18) and in that the molding (12, 14) is arranged between the inner ring (16) and the outer ring (18).

2. Apparatus as claimed in claim 1, wherein the susceptor generates a ring space (26) between the inner ring (16) and the outer ring (18), the radial extension of which substantially remains constant and in particular amounts to between half (0.5) and double (2,0) the diameter of the height of the rings.

3. Apparatus as claimed in claim 1, wherein the inner ring (16) and/or the outer ring (18) of the susceptor have an elliptical or circular shape.

4. Apparatus as claimed in claim 1, wherein both the inner ring (16) and the outer ring (18) each have a cross-section of an upright standing rectangle, the height amounting to between 20% and 120% of the diameter of the ring, preferably to between 50% and 85% and in particular to between 65% and 75% of the ring diameter.

5. Apparatus as claimed in claim 1, wherein the inner ring (16) and the outer ring (18) generate a container that is in particular closed and forms a thermal treatment chamber having a homogeneous temperature field, said container accommodating the one or more moldings (12, 14) that are to be heated and being particularly at least partially transparent to microwave radiation.

6. Apparatus as claimed in claim 1, wherein the inner ring (16) and the outer ring (18) as a susceptor absorb microwave radiation and emit thermal radiation in a homogenized manner.

7. Apparatus as claimed in claim 1, wherein the inner ring (16) and/or the outer ring (18) each form a closed circuit and are in particular embodied as semiconductors.

8. Apparatus as claimed in claim 7, wherein the susceptor is embodied as a semiconductor and has a protective layer of silicon dioxide applied on its upper surface that is also electrically insulating.

9. Apparatus as claimed in claim 1, wherein the ring-shaped susceptor elements of the susceptor are electrically insulated relative to one another and are in particular arranged on an electrically insulating surface.

10. Apparatus as claimed in claim 1, wherein each susceptor element has a substantially uniform height and/or wall thickness that in particular exceeds the height of the molding many times over.

11. Apparatus as claimed in claim 1, wherein at least one susceptor element has a circular-symmetric shape and is in particular pivot-mounted about its axis.

12. Apparatus as claimed in claim 1, wherein the wall thickness of one susceptor element (16, 18) amounts to a seventieth fraction to a fortieth fraction of the wavelength 1 of the microwave radiation generated by the microwave generator, and in particular has a thickness of between 1.8 mm and 2.5 mm.

13. Apparatus as claimed in claim 1, wherein the height of each susceptor element (16, 18) has a common factor with the wavelength 1 of the microwave generator, in particular is ½ or ¼.

14. Apparatus as claimed in claim 1, wherein the susceptor elements (16, 18) are arranged in a concentric manner relative to one another and are in particular formed integrally.

15. Apparatus as claimed in claim 1, wherein the susceptor elements (16, 18) are connected to each other by means of a circular ring-shaped bottom (30) or by means of a spacer.

16. Apparatus as claimed in claim 1, wherein a circular ring-shaped space (26) is generated between the susceptor elements (16, 18), said space (26) being provided with a bed of balls that in particular consist of densely sintered zirconium oxide and/or Al₂O₃, and/or wherein the space (26) comprises hollow balls, broken balls, powder or so-called flakes.

17. Apparatus as claimed in claim 1, wherein the suscepto is made of open-pored silicon carbide.
